(19) United States
(12) Patent Application Publication
(10) Pub. No.: US 2026/0253420 A1
(43) Pub. Date: Aug. 27, 2026

(54) Artificial Intelligence-Driven Human Motion Recognition Systems and Methods for Predetermined Motion Time System Mapping and Industrial Process Optimization

(71) Applicant: Caresoft Global Technologies Inc., Livonia, MI (US)

(72) Inventors: Manojdeep Singh Jasrotia, Darien, IL (US); Krishnamoorthy Perianna Gounder Sengottaiyan, Aurora, IL (US)

(73) Assignee: Caresoft Global Technologies Inc., Livonia, MI (US)

(21) Appl. No.: 19/547,826

(22) Filed: Feb. 24, 2026

Related U.S. Application Data
(60) Provisional application No. 63/762,313, filed on Feb. 24, 2025.

(51) Int. Cl. G06V 20/52; G05B 13/02; G06V 10/774; G06V 10/82; G06V 20/40; G06V 40/20

(52) U.S. Cl. CPC G06V 20/52; G05B 13/0265; G06V 10/774; G06V 20/40; G06V 40/20; G06V 10/82; G06V 2201/06

(57) ABSTRACT

Presented are automated motion monitoring and analysis systems for industrial process optimization, methods for making/using such systems, and memory-stored, computer code for operating such systems. A method of optimizing a manufacturing process includes an optical imaging device within a manufacturing facility capturing digital video data of a human performing multiple movements during the manufacturing process. A system controller, using a supervised machine learning (SML) model, analyzes the digital video data to identify a sequence of motions within the human's movements, and categorizes the motions into predefined motion groups. The system controller translates each cataloged action into one of multiple predefined activity descriptions, and maps each translated activity to one of multiple predefined map codes. Using a rules engine, the system controller converts each mapped activity to one of multiple time measurement unit (TMU) values, and revises the manufacturing process using the TMU values to generate a modified workflow process.

### CLAIM OF PRIORITY AND CROSS-REFERENCE TO RELATED APPLICATION

This application claims the benefit of and priority to U.S. Provisional Patent Application No. 63/762,313, which was filed on Feb. 24, 2025, and is incorporated herein by reference in its entirety and for all purposes.

### INTRODUCTION

The present disclosure relates generally to manufacturing processes for the mass production of products. More specifically, aspects of this disclosure relate to human motion monitoring systems for creating assembly line standards in industrial engineering.

Large scale manufacturing processes, such as the production of aircraft, watercraft, and automobiles, involve highly complex machines and systems with meticulously planned and controlled workflows. Consequently, assembly line operators in such manufacturing systems must account for a host of design parameters, fabrication tolerances, and environmental constraints in order to optimize predefined production processes and the deployment of different technologies in order to improve manufacturing efficiency and safety. Modern-day automobiles, for example, require the assembly of tens of thousands of parts using a multitude of different joining techniques, including bolting, crimping, welding, riveting, and clamping. Assembly line operators are used in both manual and partially automated manufacturing systems to perform a variety of tasks at various stages of the production process. These line operators may be segregated into individual work cells to perform manual tasks or may work alongside robotic cells on the assembly line to facilitate or supervise automated tasks. As workpieces pass down the assembly line, each workpiece may be held within a jig or fixture to secure the workpiece in place to complete a singular operation or a series of operations designated for that workstation.

Data for large scale manufacturing processes has historically been collected manually, often requiring an industrial engineer or dedicated operator to monitor individual procedures and related protocols while documenting batches of specific data for subsequent evaluation. This collected data is then analyzed in order to diagnose systemic problems in the workflow process or assembly line environment and derive ameliorative action items to improve the manufacturing operations. Such manual approaches to manufacturing process optimization are inherently inefficient, often taking place on a time scale of months or years with the attendant labor and overhead costs. Moreover, manual data collection and analysis is inherently prone to human-borne error along with innate shortcomings due to limited data.

### SUMMARY

Presented below are automated motion monitoring and analysis (M&A) systems with attendant control logic for manufacturing process optimization, methods for making and methods for operating such systems, and memory-stored, computer-readable code for provisioning such system control logic. By way of non-limiting example, an artificial intelligence (AI) driven human motion recognition system provisions Predetermined Motion Time System (PMTS) mapping and process optimization in industrial engineering applications. Using Deep Neural Network (DNN) supervised machine learning (SML) models, for example, the system automates human body motion detection, recognition, and tracking to generate improved assembly line standards for large-scale manufacturing workflow procedures. In addition to enhancing and streamlining manufacturing process optimization, such systems may also automate downstream activities for Value-Added (VA), Non-Value-Added (NVA), and Semi-Value-Added (SVA) tasks to optimize manufacturing processes.

Disclosed motion monitoring and analysis systems may be cloud-based, AI-driven platforms and may be implemented to improve existing technologies, such as in industrial engineering applications for:
Time Standard Development: automating and accelerating the process of time standard creation using Predetermined Motion Time Systems; the platform may be PMTS agnostic and may create time standards (e.g., in Method-Time Measurement (MTM), Maynard Operation Sequence Technique (MOST), or Modular Arrangement of Predetermined Time Standards (MODAPTS)) by analyzing human movement and directly converting the movements into code.
Process Optimization: providing real-time data and insights to optimize workflows.
Engineer and Plant Use: industrial engineers may set standards on the manufacturing floor to determine the cost of production; manufacturing engineers may analyze and optimize processes on factory floors to reduce production costs and improve product competitiveness; operations and plant managers may optimize resource allocation and production efficiency; quality assurance specialists may ensure process compliance and improve quality based on NVA analysis of time standards. Logistics engineers may optimize process logistics (e.g., indirect labor) inside the four walls of the manufacturing facility. IT administrators may oversee software integration and system security.

Disclosed AI-driven human motion recognition platforms may be scaled and adapted to particular applications across various sectors within the manufacturing industry, including automotive (e.g., reduce analysis time in assembly lines), off-highway equipment manufacturing: (e.g., streamline labor-intensive processes), and electronics and heavy machinery production (e.g., optimize complex workflows).

It is envisioned that disclosed motion monitoring and analysis systems and methods may be utilized for real-time human movement analysis using supervised ML AI models to break down tasks into elemental motions for precise time standards. Disclosed systems and methods may also be integrated with “Industry 4.0 Systems”, including compatibility with MES and Enterprise Resource Planning (ERP) platforms, to help ensure seamless operational improvements. Disclosed systems and methods may also be implemented for production process waste analysis (e.g., “Muda, Muri, and Mura”) to enhance productivity and reduce waste by identifying process inefficiencies and areas for improvement. Disclosed system software may offer scalability, flexibility, and efficiency to provide a transformative tool for industries looking to embrace advanced manufacturing technologies and achieve significant cost reductions through automation and data-driven decision-making.

Attendant benefits and improvements over existing technology for at least some of the disclosed concepts may include reducing dependence on human capital and, thus, obviating issues associated with the unavailability of skilled personnel due to a widening skill gap in the industry. In addition, increased efficiencies provided by automated, AI-driven time standard development may help to eliminate traditional labor-intensive and time-consuming PMTS techniques that require highly trained personnel with concomitant increases in labor and operational costs. Other attendant benefits may include reducing human-borne errors and inconsistencies by eliminating manual time studies that are prone to mistakes and subjectivity, which lead to inconsistencies in process analysis and optimization. Disclosed motion recognition tools may offer effective and simplified integration with Manufacturing Execution Systems (MES) and other Industry 4.0 technologies. Additional benefits may include providing real-time data processing and actionable insights, which helps to expedite decision-making and accelerate process optimization. In addition to the foregoing improvements, disclosed human motion recognition systems and methods may also help to reduce computational load, minimize total processing resources, and reduce server memory usage.

Aspects of this disclosure are directed to automated motion monitoring/analysis systems, process, and programmable control logic for optimizing operation of industrial systems. In an example, a method is presented for governing a manufacturing process for mass producing a product. This representative method includes, in any order and in any combination with any of the above and below disclosed options and features: capturing, e.g., by one or more optical imaging devices within a manufacturing facility, digital video data of a human performing multiple movements during the manufacturing process; analyzing, e.g., via a resident or remote microcontroller, central processor, control module, logic device, or network of controllers/processors/modules/devices (collectively “system controller”) using a supervised machine learning (SML) model, the digital video data to identify a sequence of recognized motions within the human's recorded movements; categorizing, e.g., via the system controller, the motions into predefined motion groups to generate a set of cataloged actions; translating, e.g., via the system controller, each of the cataloged actions into one of multiple predefined activity descriptions to generate a set of actionable activities; mapping, e.g., via the system controller, each of the actionable activities to one of multiple predefined map codes to generate a set of mapped activities; converting, e.g., via the system controller using an automated software rules engine, each of the mapped activities to one of multiple time measurement unit (TMU) values; and revising, e.g., via the system controller using the TMU values assigned to the mapped activities, the manufacturing process to generate a modified (enhanced) workflow process for mass producing products.

Aspects of this disclosure are also directed to computer-readable media (CRM) containing controller-executable instructions for optimizing operation of industrial systems. In an example, a non-transient CRM stores instructions that are executable by one or more processors of a system controller of a smart manufacturing system. The CRM-stored instructions, when executed by the processor(s), cause the system controller to perform operations, including: receiving, from an optical imaging device within a manufacturing facility, digital video data of a human performing multiple movements during a manufacturing process; analyzing, using a supervised machine learning (SML) model, the digital video data to identify a sequence of motions within the multiple movements; categorizing each motion in the sequence of motions into one of multiple predefined motion groups to generate a set of cataloged actions; translating each action in the set of cataloged actions into one of multiple predefined activity descriptions to generate a set of actionable activities; mapping each actionable activity in the set of actionable activities to one of multiple predefined map codes to generate a set of mapped activities; converting, using a rules engine, each mapped activity in the set of mapped activities to one of multiple time measurement unit (TMU) values; and revising the manufacturing process using the TMU values assigned to the mapped activities to generate a modified (enhanced) workflow process for mass producing products.

For any of the herein describes systems, methods, and CRM, analyzing digital video data to identify a sequence of motions may include: training the SML model with a labelled data set, which contains labelled motion data points with corollary action labels, to perform comprehensive motion analysis; and detecting, e.g., via the system controller using the trained SML model, movement patterns across the human's body within the movements performed during the manufacturing process to distinguish elemental motions contained therein into the sequence of motions. As a further option, generating a set of actionable activities may include: retrieving, e.g., via the system controller from one or more resident or remote system databases, a respective set of standardized activity descriptions assigned to each predefined motion group; and converting each motion within each predefined motion groups to one of the standardized activity descriptions assigned to the predefined motion group of that motion. These disclosed features help to improve the efficiency, productivity, and output quality of existing manufacturing workflow processes.

For any of the herein describes systems, methods, and CRM, generating a set of mapped activity codes may include: retrieving, e.g., via the system controller from the system database(s), a standardized mapping code ascribed to each of the standardized activity descriptions; and assigning one of the standardized mapping codes to each of the actionable activities. As a further option, converting each mapped activity may include: retrieving, e.g., via the system controller from the system database(s), a standardized TMU value ascribed to each standardized mapping code; and assigning a corresponding one of the standardized TMU values to each mapped activity in each set of mapped activities. As another option, revising the manufacturing process may include calculating, e.g., via the system controller, a mathematical sum of the TMU values of the converted set of mapped activities; and calculating, e.g., via the system controller, a TMU time standard for the manufacturing process by multiplying the mathematical sum of the TMU values by a predefined TMU scalar. In this instance, the manufacturing process may be revised based on the calculated TMU time standard.

For any of the herein describes systems, methods, and CRM, revising the manufacturing process may include labelling, e.g., via the system controller, each actionable activity as either: a value-add (VA) activity when that actionable activity directly contributes to a production outcome of the manufacturing process; a non-value-add (NVA) activity when that actionable activity directly detracts from the production outcome of the manufacturing process; or a semi-value-add (SVA) activity when that actionable activity indirectly contributes to the production outcome of the manufacturing process. In this instance, revising the manufacturing process may include eliminating any/all actionable activities that are labelled as an NVA activity, and revising any/all actionable activities that are labelled as an SVA activity.

For any of the herein describes systems, methods, and CRM, the manufacturing facility may contain a network of Internet of Things (IoT) devices used during the manufacturing process (e.g., sensors, machines, cyber-physical devices, smart wearable devices, additive manufacturing hardware, etc.). In this instance, revising the manufacturing process may include modifying a set of programmed device actions of one or more of the network IoT devices based on the modified workflow process. As another option, the manufacturing facility may contain one or more robotic device that operate in conjunction with the human for the manufacturing process. In this instance, revising the manufacturing process may include modifying a set of programmed robot actions of a robotic device based on the modified workflow process. Revising the manufacturing process may include generating and outputting an interactive operational dashboard that presents the modified workflow process and multiple user-selectable and modifiable key performance indicators (KPIs).

For any of the herein describes systems, methods, and CRM, the predefined motion groups may include a body bending group, a knee bending group, a head movement group, a leg movement group, and/or a posture group. As another option, the predefined activity descriptions may include a forward or backward movement for the body bending group, a crouching or kneeling movement for the knee bending group, a tilt, turn, or nod movement for the head movement group, a walk or step movement for the leg movement group, and/or an ergonomic risk or inefficient movement for the posture group. Moreover, analyzing the digital video data may include evaluating, e.g., via the system controller using the SML model, the movements performed by the human to detect one or more hand movements, one or more finger movements, one or more grasping movements, one or more arm movements, one or more torso movements, one or more head movements, one or more body bending movements, one or more knee bending movements, posture analysis, and/or one or more leg movements. Revising the manufacturing process may include performing the manufacturing process in accordance with the modified workflow process. Revising the manufacturing process may also include governing one or more controller-automated robots and/or machines in accordance with the modified workflow process.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic diagram illustrating a representative AI-driven human motion recognition system for Predetermined Motion Time System mapping and industrial process optimization in accord with aspects of the present disclosure.

FIG. 2 is a flowchart illustrating a representative human motion recognition control protocol for providing industrial process optimization, which may correspond to non-transient, memory-stored instructions that are executable by a resident or remote microprocessor, control module, programmable logic circuit, central controller, or other integrated circuit (IC) device or network of processors/controllers/circuits/modules/ devices/etc. in accord with aspects of the disclosed concepts.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “exactly or reasonably close to,” or any logical combination thereof, for example.

In industrial operations and engineering, creating time standards for tasks performed as part of industrial process optimization has traditionally been a labor-intensive and time-intensive manual process. Historically, time standard creation required an industrial engineer or dedicated operator to personally observe the human motions associated with a given process, record associated activities, and correlate the activities to predefined codes, such as the Predetermined Motion Time System (PMTS) codes associated with MOST or MTM-based software platforms. These approaches often suffer from human-borne error, inconsistency, and inefficiency, which leads to inaccurate time standards and undetected operational inefficiencies.

Presented herein are AI-driven motion monitoring and analysis (M&A) platforms that optimize industrial operations by increasing the efficiency and consistency of time standard development practices while eliminating human error associated therewith. A networked array of high-definition optical sensors may be used, for example, to monitor and record movement of an operator within a predefined work envelope to help automate motion identification and classification as a predecessor to time standard generation. The identified and classified motions are mapped to a set of standardized PMTS codes and, once mapped, are then correlated to standardized time values that define forecasted allocations of time for each actionable activity associated with a subject operation. In addition to generating accurate time standards, the M&A platform may identify inefficiencies-MUDA (wastefulness), MURI (uselessness), and MURA (futility) while providing actionable insights for process modification and improvement. These disclosed features help to improve the efficiency, productivity, and output quality of existing manufacturing workflow processes.

Disclosed M&A platforms employ a suitable AI-based algorithm, such as a decision-tree SML model or a convolutional DNN model, to replicate human motion detection, targeting, and identification that is adaptable to multiple PMTS methodologies. While traditional methods rely on extensive post-hoc analysis, making real-time insights appear unachievable without considerable manual effort, AI-driven automated analysis may instantly highlight inefficiencies and workflow inconsistencies to derive real-time insights that are both practical and ergonomic. In addition, disclosed automated PMTS has been shown to reduce analysis time by up to 75% with a concomitant reduction in overhead and labor costs. Beyond time and cost savings, the system construct enables cross utilization of the tool and seamless adoption across various manufacturing lines both within an organization and across various satellite footprints that may help to bring in data sanity, repeatability, and ROI with mass adoption.

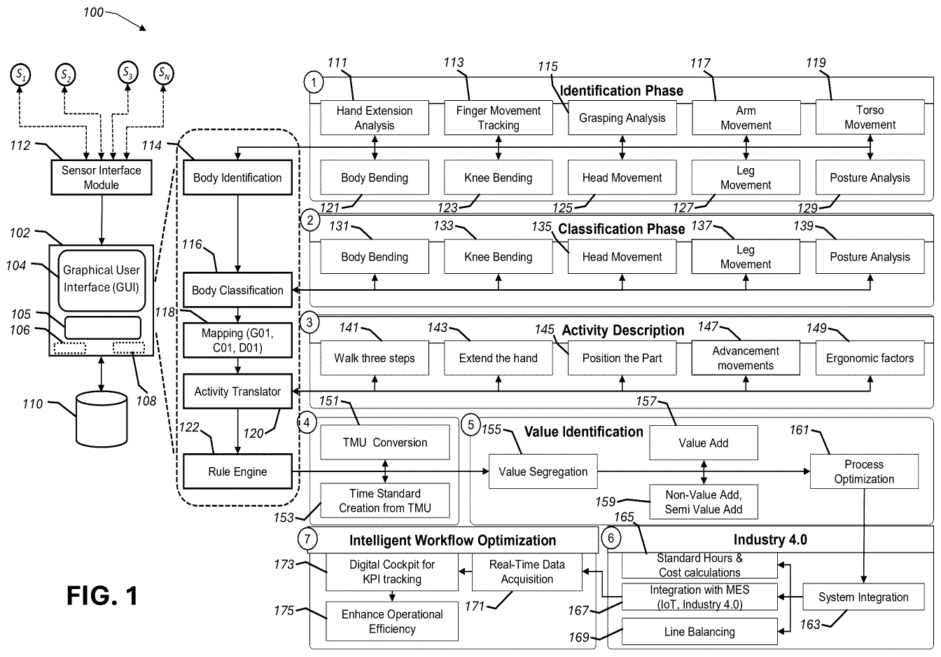

Referring now to the drawings, wherein like reference numbers refer to like features throughout the several views, there is shown in FIG. 1 a representative AI-driven human motion recognition system 100 for PMTS mapping and industrial process optimization. The illustrated motion recognition system 100—also referred to herein as “motion monitoring and analysis system” or “monitoring system” for brevity—is merely an exemplary application with which aspects of this disclosure may be practiced. In the same vein, implementation of the present concepts for optimizing a manufacturing process used to mass produce a product on an assembly line should also be appreciated as a non-limiting implementation of disclosed features. As such, it will be understood that novel features of this disclosure may utilized to optimize any logically relevant industrial operation and may be incorporated into other motion recognition system architecture. Moreover, only select components of the motion recognition system 100 is shown and will be described in detail herein. Nevertheless, the systems discussed below may include numerous additional and alternative features, and other available peripheral hardware, for carrying out the various methods and functions of this disclosure.

The motion recognition system 100 of FIG. 1 is presented as a back-office (BO) control center architecture that contains a server-class computer work station 102 with an interactive graphical user interface (GUI) 104 through which a user interacts with the system. The work station 102 may be generally composed of one or more processors 106, each of which may be embodied as a discrete microprocessor, an application specific integrated circuit (ASIC), a dedicated control module, a central processing unit (CPU), and combinations thereof, and assorted user input controls 105 (e.g., touchpads, touchscreens, key pads, etc.). The processor(s) 106 may be operatively coupled to a real-time clock (RTC) and one or more electronic memory devices 108, each of which may take on the form of a CD-ROM, magnetic disk, IC device, solid-state drive (SSD) memory, hard-disk drive (HDD) memory, phase-change memory, flash memory, semiconductor memory (e.g., various types of RAM or ROM), etc. A System Database Storage device 110, which may be in the nature of a resident server-class database or a remote cloud-based storage service, may aggregate, filter, collate, map and store some or all collected and analyzed data for future reference and analysis. Unlike conventional desktop and laptop computers, which offer limited storage, processing, and data management capabilities, server-class computers have more powerful processors, larger memory capacities, and advanced data integration features to enable high uptime and continuous operation with protective redundancies and to handle heavy workloads.

System Data Storage device 110 may store real-time digital image data captured through a sensor interface module 112 from a networked array of optical sensing devices S₁, S₂, S₃, . . . S_{N}, each of which may be in the nature of machine vision (MV) area scan cameras, high-resolution MV industrial cameras, self-contained MV smart cameras, and 3D MV scan cameras. Unlike conventional cameras, a “machine vision camera” is a specialized type of optical sensing device that is designed specifically for industrial and automation applications, capturing high-resolution images with precise color accuracy and consistent lighting to accurately capture details for computational analysis. Where a regular camera may prioritize aesthetics and wider dynamic range, MV cameras employ specialized lenses, wavelength filters, adjustable frame rates, modulated trigger inputs, etc., for precise analysis and decision-making applications. These optical sensing devices S₁, S₂, S₃, . . . S_{N} may be arranged in a predetermined pattern around a predefined work envelope within a manufacturing facility.

Work station 102 may contain or, if desired, may communicate over a high-integrity serial bus system of a controller area network (CAN) with a network of interoperable control modules for performing motion recognition and PMTS mapping for industrial process optimization, examples of which are shown as a body identification module 114, a body classification module 116, a PMTS code mapping module 118, an activity translator module 120, and a time measurement rule engine module 122. During an Identification Phase of the industrial process optimization routine, one of the work station processors 106 may prompt the sensor interface module 112 to collect digital image data captured by one or more of the optical sensing devices S₁-S_{N}. The sensor-generated information may include real-time digital video data of a human performing multiple movements when completing an assembly line operation during a manufacturing process for mass-producing a product. In evaluating these movements, the body identification module 114 may attempt to detect, target, and identify only specific motions that are prevalent to the completing the assembly line operation while disregarding superfluous and irrelevant motions. In FIG. 1, the Identification Phase may include:
Hand Extension Analysis Component 111: detects and identifies reaching actions for interaction with parts or tools
Finger Movement Tracking Component 113: detects and identifies fine motor skills of forelimb digits for grasping or manipulating objects.
Grasping Analysis Component 115: detects and identifies hand-object interaction and holding patterns.
Arm Movement Component 117: detects and identifies movement patterns across the upper limbs
Torso Movement Component 119: detects and identifies movement patterns across the thoracic and abdominal body segments
Body Bending Analysis Component 121: detects and identifies bending angles of torso to assess related posture and task ergonomics
Knee Bending Analysis Component 123: detects and identifies bending angles of lower limbs to assess posture and task ergonomics
Head Movement Component 125: detects and identifies head motion for tasks such as locating and positioning parts
Leg Movement Component 127: detects and identifies leg motion for tasks such as walking and positioning parts
Posture Analysis Component 129: monitors posture during activities to identify ergonomic risks
   Precision motion identification during the Identification Phase may generate a sequence of operation-relevant motions that form the computation data input for the Classification Phase and subsequent processes.

Video input may be processed by the motion recognition system 100 using an AI-based model to provision fast, accurate, and consistent identification of individual motions. Using a trained and supervised machine learning model, for example, the body identification module 114 analyzes the digital video data to detect, target and identify a sequence of motions within the operator's movements during performance of the assembly line operation. The motion identification process may follow a structured pipeline:
1. Video Capture & Preprocessing: the system captures video input and applies stabilization, background noise filtering, and human segmentation;
2. Pose Estimation: AI-based skeletal monitoring detects and tracks key body points (e.g., shoulders, wrists, knees, ankles, etc.);
3. Motion Segmentation: trained SML model evaluates sequential frame differences to detect and track movement;
4. Feature Extraction: AI model analyzes motion attributes, such as hand extension, finger movements, arm motion, leg movement, knee bending, and posture changes; and
5. Motion Labeling: each detected motion is assigned a label, such as “reaching,” “grasping,” “walking.”
   This automated motion recognition process may help to eliminate manual intervention, ensure consistency, accuracy, and scalability in motion analysis.

Upon completion of the Identification Phase, the body classification module 116 may execute a Classification Phase to categorize the identified motions into predefined motion groups. While not per se limited, each motion in the sequence of operation-relevant motions that was output by the body identification module 114 may be classified into one of the following multi-file relational database tables:
Body Bending Table 131: contains tasks involving forward or backward movement of the human body
Knee Bending Table 133: contains tasks involving crouching or kneeling actions
Head Movement Table 135: contains tasks involving tilts, turns, or nodding of the human head
Leg Movement Table 137: contains tasks involving walking or stepping
Posture Analysis Table 139: detecting ergonomic risks or inefficiencies
   Precision motion classification during the Classification Phase may generate a cataloged set of organized and classified actions that form the computation data input for Motion Mapping and Activity Description phases of the industrial process optimization protocol.

Continuing with the foregoing discussion, each time the motion recognition system 100 identifies an individual motion within a digital video data set, it systematically categorizes that identified motioned into a corresponding predefined group. This may be achieved through the following trained ML-based classification process:
1. Pattern Recognition & Clustering: the AI-driven engine maps detected motions to pre-defined categories based on movement characteristics
2. Motion Categorization:
   Body Bending: forward or backward bending.
   Knee Bending: crouching or kneeling.
   Arm Extension: full/half measured by elbow extension
   Hand Movement: fingers open and close
   Wrist Movement: clockwise and counter-clockwise; angular rotation
   Head Movement: nodding, tilting, and turning
   Leg Movement: walking and stepping
   Posture Analysis: detecting ergonomic inefficiencies
3. Decision Tree & Confidence Scoring: The system assigns a confidence score to the classification, ensuring precision.
   Automated and structured classification of identified motions may help to simplify the standardizing of identified motions for downstream processing.

Upon completion of the Classification Phase, the PMTS code mapping module 118 and the activity translator module 120 of FIG. 1 may respectively execute a Motion Mapping phase, which maps converted motions to PMTS codes, and an Activity Description phase, which converts cataloged motions into actionable activity descriptions. By way of example, and not limitation, the classified actions output by the body classification module 116 may each be translated into a corresponding one of the following specific, standardized activity descriptions:
first predefined activity description 141: “walk three steps” for gaited movements and similar actions
second predefined activity description 143: “extend hand” for reaching movements and similar actions
third predefined activity description 145: “position part” for placement movements and similar actions
fourth predefined activity description 147: “advanced movement” for complex tasks and similar actions
fifth predefined activity description 149: “ergonomic factors” for movements and similar actions that affect efficiency and comfort in a working environment
   The classified motions are translated into meaningful activity descriptions, making them useful for industrial process mapping. Each action in a given set of cataloged actions may be translated into one of the predefined activity descriptions to thereby generate a set of actionable activities.

Prior to, contemporaneous with, or after translating the catalogued actions, the mapping module 118 may map each actionable activity to a corresponding one of multiple predefined map codes (e.g., PMTS Mapping Codes G01, C01, D01, etc.) and generate therefrom a set of mapped activities used for time standard creation. A non-limiting example of PMTS code mapping may include assigning actionable activities as follows:
General Moves
   A—Action Distance
   B—Body Motion
   G—Gain Control
   P—Placement
Controlled Moves
   M—Move Controlled
   X—Process Time
   I—Alignment
Tool Uses
   F—Fasten
   L—Loosen
   C—Cut
   S—Surface Treat
   M—Measure
   R—Record
T—Think
   It is envisioned that similar code assignments may be performed for MTM and MODAPTS applications. Automated AI-driven motion-to-code mapping may eliminate manual intervention, thus ensuring uniformity in activity descriptions and more accurate time measurement while providing cross-industry standardization (e.g., ensuring categorized motions are converted into actionable industrial data).

Mapped and translated activities are fed into the rule engine module 122 of FIG. 1 to convert each activity to a corresponding time measurement unit (TMU) value as part of a Time Standard Conversion phase. The rule engine module 122, for example, may automate the conversion of activity codes into TMU values using a set of predefined logic rules to help ensure quantifiable time standards for each task. The rule engine 122 may reference System Database Storage device 110 to call-up a PMTS code lookup table that contains predefined TMU values. A TMU conversion subroutine 151 then assigns a corresponding one of these standardized TMU values to each of the mapped activities based on their respective mapping code. In tandem, a time standard conversion subroutine 153 calculates a mathematic sum of the TMU values and then applies a predefined TMU scalar to the sum to derive a final time value. A non-limiting example of predefined rules-based TMU assignment follows:
Example of code-A6 B6 G1 A1 B0 P3 A0
   A6 =Walk three to four steps to object location
   B6 =Bend and arise to gain control of the object
   G1=Gain control of one light object
   A1=Move object a distance within reach
   B0 =No body motion
   P3 =Place object with adjustments
   A0 =No return
TMU standards provide accurate and reliable time measurements. One TMU may be equivalent to 0.00001 hours. The following conversion table is provided for calculating standard time:
   1 TMU=0.00001 hours; 1 hour=100,000 TMU
   1 TMU=0.0006 minutes; 1 minute=1667 TMU
   1 TMU=0.036 seconds; 1 second=27.8 TMU
The time value in TMU for each sequence model in Basic MOST may then be calculated by adding the index values and multiplying the sum by 10
A6+B6+G1+A1+B0+P3+A0 [symbol]
   (Ignore the alphabets and only consider numerical values)
6+6+1+1+0+3+0=17
   Multiply by ten: 17×10=170 TMU
   170 Tmu×0.036 Sec/tmu=6.12 Seconds
   The system assigns TMU values using industry-standard conversion tables.
Error Correction & Validation:
   Automated checks prevent miscalculations.
   If necessary, human intervention is required only for outlier activities.

This automated TMU assignment protocol may help to ensure high accuracy, consistency, and efficiency in measuring work content. In addition, this logic may be applied for any type of manufacturing process across various manufacturing industries.

After completing time standard creation, the motion recognition system 100 may conduct a Value Identification phase to identify value-added (VA), semi-value-added (SVA), and non-value-added (NVA) activities without overlooking inefficiencies in the tasks completed by the human operator as part of the manufacturing process. For instance, a value segregation subroutine 155 may segregate actionable activities based on their contribution to the process into: (1) a VA database bin 157 for all value-add activities that directly contribute to the production outcome; or (2) an SVA/NVA database bin 159 for (a) all non-value-add activities that are wasteful and, thus, does not contribute to the production outcome, and (b) all semi-value-add activities that indirectly support production. Examples of NVA activities may include packing/unpacking materials, organizing materials, retrieving tools, organizing tools, waiting (e.g., due to cycle time, missing materials, upstream delays, etc.), and paper filing. Some non-limiting examples of SVA activities may include picking up, holding, and positioning tools/materials. And some examples of VA activities may include bending or cutting materials, packing spare parts, fitting, welding, gluing, inserting, and painting the product. The Value Identification phase may help to provide actionable insights for waste elimination and process optimization while also outputting the requisite data for process improvement analysis and optimization, as indicated by process optimization subroutine 161 of FIG. 1.

Disclosed time study methods enable integration with Industry 4.0 Systems, including compatibility with MES and ERP platforms, to help ensure seamless operational improvements. With all motions identified, classified, described, and assigned time values, system integration subroutine 163 of FIG. 1 integrates the process improvements output by process optimization subroutine 161 with data-driven, digital-tech powered manufacturing and industrial processes, e.g., connecting the workflow to modern Industry 4.0 systems for better coordination and monitoring, real-time tracking, and process optimization. An hours & cost subroutine 165 provides a standard hours and cost calculation that is automatically derived from the assigned TMU values. An MES integration subroutine 167 enables workflow integration with MES and IoT platforms to enables real-time tracking. A line balancing subroutine 169 helps to ensure even workload distribution, e.g., across various production lines within a single manufacturing facility or a single manufacturing entity. An example of the Industry 4.0 Integration phase follows:
Seamless Mes Integration:
   AI-driven time studies feed directly into Manufacturing Execution System (MES)
   New generation machines enabled to talk with real-time tracking system, traditional legacy machines would include an intermediate MT connect configuration to pull the data to feed to the tracking system
   Data-driven line balancing and production planning become automated
IoT-Enabled Motion Sensors:
   Wearable or fixed IoT sensors detect motion and update system in real-time
   Data flows directly into machine learning models for continuous improvement
Real-Time Performance Monitoring:
   Digital dashboards track cycle times, ergonomic risks, and inefficiencies
   Alerts notify managers of process bottlenecks or out-of-threshold values
      By leveraging AI, MES, and IoT, the motion recognition system 100 enables real-time monitoring, reducing inefficiencies and enhancing overall manufacturing productivity. The motion recognition system 100 may then output a real-time and connected production environment while enhancing transparency and control.

An Intelligent Workflow Optimization phase may then be executed to provision continuous process improvements that are unhindered by a lack of real-time data and KPI monitoring. For instance, a Real-Time Data Acquisition subroutine 171 may capture live data for dynamic decision-making that enables real-time integration and optimization. A Digital Cockpit interface 173 may provide a visual, interactive dashboard for tracking key performance indicators (KPIs), such as cycle times, ergonomics, and productivity. In addition, an Enhanced Operational Efficiency subroutine 175 may provide data-driven insights that enable waste elimination and ergonomic improvements. The Intelligent Workflow Optimization phase may output a self-optimizing, intelligent workflow system that enhances productivity and reduces operational waste.

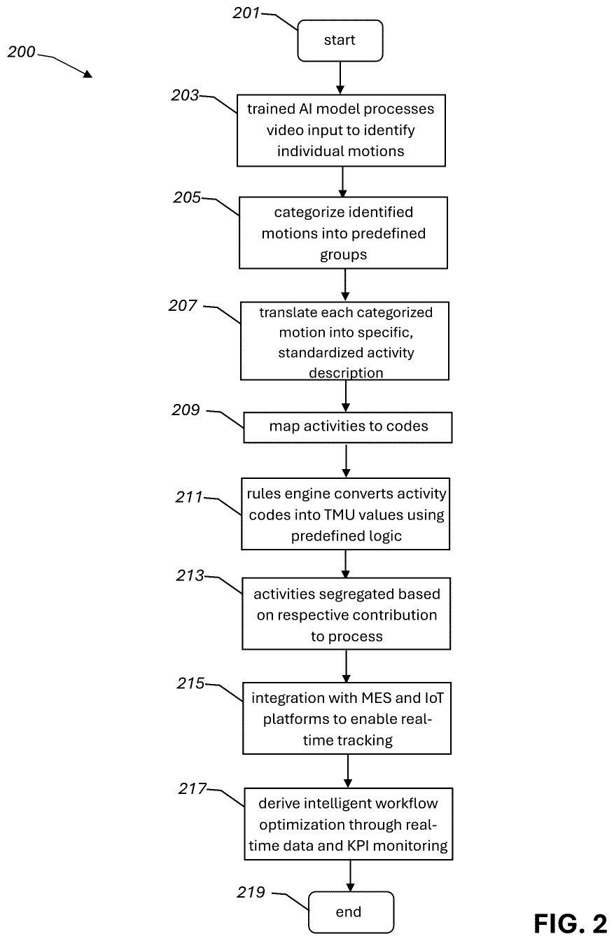

With reference next to the flowchart of FIG. 2, an improved method or control protocol for human motion recognition to provide PMTS mapping and industrial process optimization is generally described at 200 in accordance with aspects of the present disclosure. Some or all of the operations illustrated in FIG. 2 and described in further detail below may be representative of an algorithm that corresponds to non-transitory, processor-executable instructions that are stored, for example, in main or auxiliary or remote memory (e.g., resident memory device 108 and/or System Database Storage device 110 of FIG. 1). These instructions may be executed, for example, by an electronic controller, processing unit, dedicated control module, logic circuit, or other module or device or network of controllers/modules/devices (e.g., processor(s) 106 and/or control modules 114, 116, 118, 120, 122 of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 200 begins at START terminal block 201 of FIG. 2 with instructions to initialize operation of an automated motion monitoring and analysis (M&A) system, such as human motion recognition system 100 of FIG. 1. At process block 203, a trained AI model processes video input to identify a series of individual motions. Motion identification may begin with one or more optical imaging devices, such as optical sensing devices S₁, S₂, S₃, . . . S_{N}, capturing digital video data of a human performing multiple movements during a manufacturing process. A system controller, such as processor(s) 106 and body identification module 114, uses a supervised machine learning model to analyze the digital video data and thereby identify a sequence of motions within the recorded human movements. Digital video analysis may require training the SML model with a labelled data set containing labelled motion data points (e.g., previously vetted and weighted data points) with corollary action labels (e.g., approved “correct” outputs) to perform comprehensive motion analysis. The trained SML model may then be used to detect movement patterns across the body of the operator within the movements performed during the manufacturing process to distinguish elemental motions contained therein into the sequence of motions.

Advancing to process block 205, method 200 may categorize the motions identified at process block 203 into predefined groups. For instance, the system controller may categorize each identified motion into one of multiple predefined motion groups to generate a set of cataloged actions. Once catalogued, method 200 may execute process block 207 and translate the categorized motions into specific, standardized activity descriptions. By way of example, the system controller may convert each action in the set of cataloged actions into one of multiple predefined activity descriptions to generate a set of actionable activities. Generating a set of actionable activities may include accessing a system database to retrieve therefrom a respective set of standardized activity descriptions assigned to each of the predefined motion groups. Each motion within each predefined motion group is then converted to one of the standardized activity descriptions assigned to the predefined motion group of that motion.

In tandem with translating the categorized motions into standardized activity descriptions, method 200 may execute process block 209 and map the set of actionable activities to standardized PMTS codes. The system controller, for example, may assign each actionable activity to one of multiple predefined map codes to generate a set of mapped activities. Generating a set of mapped activity codes may include accessing a system database to retrieve therefrom a set of standardized mapping codes, each of which is ascribed to a standardized activity description. A standardized mapping code is then assigned to each of the actionable activities.

Method 200 of FIG. 2 may thereafter execute process block 211 and automate conversion of the translated and mapped activities into corresponding time values based on predefined logic set forth by a rules engine (e.g., JSON-based rules engine with dynamically executed user-defined parameters). System processor(s) 106, in collaboration with rule engine module 122 may convert each mapped activity in the set of mapped activities to one of multiple time measurement unit values. Converting a mapped activity may include accessing a system database to retrieve therefrom a set of standardized TMU values each ascribed to one of the standardized mapping codes. A corresponding standardized mapping code is then assigned to each mapped activity in the set of mapped activities. After assigning the TMU values, the method 200 may concomitantly calculate a mathematical sum of the TMU values of the converted set of mapped activities, and then calculate a TMU time standard for the manufacturing process by multiplying the mathematical sum of the TMU values by a predefined TMU scalar.

With continuing reference to FIG. 3, method 200 may execute process block 213 and segregate the translated, mapped, and converted activities based on their respective contributions to the industrial process. System processor(s) 106 may call-up value segregation subroutine 155 and label each actionable activity in the set of actionable activities as: (1) a value-add activity, if that actionable activity directly contributes to a production outcome of the subject industrial process; (2) a non-value-add activity, if that actionable activity directly detracts from the production outcome of the subject industrial process; or (3) a semi-value-add activity, if that actionable activity indirectly contributes to the production outcome of the manufacturing process. To optimize the subject industrial process, method 100 may eliminate any actionable activity labelled as an NVA activity and may revise any actionable activity labelled as an SVA activity.

Advancing to process block 215, method 200 may automate integration of an optimized workflow with an MES/IoT platform. At the same time, method 200 may derive an intelligent workflow optimization through real-time data analysis and KPI monitoring, as indicated at process block 217. Process optimization subroutine 161 of FIG. 1, for example, may use the assigned TMU values and value identification labels to revise the subject industrial process to thereby generate a modified workflow process. In some applications, the manufacturing facility for performing a manufacturing process to mass-produce a product may contain a network of IoT devices used during the manufacturing process. Revising the manufacturing process in light of the optimized workflow may include modifying respective sets of programmed device actions of one or more automated devices in the network IoT devices based on revised metrics set forth in the modified workflow. In some applications, the manufacturing facility may contains one or more robotic devices that operate in conjunction with a human operator to perform tasks as part of the subject manufacturing process. Revising the manufacturing process in light of the optimized workflow may include modifying respective sets of programmed robot actions of one or more robotic devices based on revised operating parameters set forth in the modified workflow process. Process block 217 may also include generating an interactive graphical user interface (GUI) in the form of an operational dashboard, which presents the modified workflow process and multiple user-selectable and modifiable key performance indicators (KPIs). Upon completion of some or all of the control operations presented in FIG. 2, method 200 may advance to END terminal block 219 and temporarily terminate or, optionally, may loop back to terminal block 201 and run in a continuous loop.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of governing a manufacturing process for producing a product, the method comprising:
capturing, by an optical imaging device within a manufacturing facility, digital video data of a human performing multiple movements during the manufacturing process;
analyzing, via a system controller using a supervised machine learning (SML) model, the digital video data to identify a sequence of motions within the multiple movements;
categorizing, via the system controller, each motion in the sequence of motions into one of multiple predefined motion groups to generate a set of cataloged actions;
translating, via the system controller, each action in the set of cataloged actions into one of multiple predefined activity descriptions to generate a set of actionable activities;
mapping, via the system controller, each actionable activity in the set of actionable activities to one of multiple predefined map codes to generate a set of mapped activities;
converting, via the system controller using a rules engine, each mapped activity in the set of mapped activities to one of multiple time measurement unit (TMU) values; and
revising, via the system controller using the TMU values assigned to the mapped activities, the manufacturing process to generate a modified workflow process.

2. The method of claim 1, wherein analyzing the digital video data to identify the sequence of motions includes:
training the SML model with a labelled data set containing labelled motion data points with corollary action labels to perform comprehensive motion analysis; and
detecting, using the trained SML model, movement patterns across the body of the human within the movements performed during the manufacturing process to distinguish elemental motions contained therein into the sequence of motions.

3. The method of claim 1, wherein generating the set of actionable activities includes:
retrieving, via the system controller from a system database, a respective set of standardized activity descriptions assigned to each of the predefined motion groups; and
converting each motion within each of the predefined motion groups to one of the standardized activity descriptions assigned to the predefined motion group of the motion.

4. The method of claim 3, wherein generating the set of mapped activity codes includes:
retrieving, via the system controller from the system database, a standardized mapping code ascribed to each of the standardized activity descriptions; and
assigning one of the standardized mapping codes to each of the actionable activities.

5. The method of claim 4, wherein converting each of the mapped activities includes:
retrieving, via the system controller from the system database, a standardized TMU value ascribed to each of the standardized mapping codes; and
assigning a corresponding one of the standardized TMU values to each of the mapped activities in the set of mapped activities.

6. The method of claim 1, further comprising:
calculating a mathematical sum of the TMU values of the converted set of mapped activities; and
calculating a TMU time standard for the manufacturing process by multiplying the mathematical sum of the TMU values by a predefined TMU scalar, wherein revising the manufacturing process is based on the calculated TMU time standard.

7. The method of claim 1, further comprising labelling, via the system controller, each actionable activity in the set of actionable activities as:
a value-add (VA) activity when the actionable activity directly contributes to a production outcome of the manufacturing process;
a non-value-add (NVA) activity when the actionable activity directly detracts from the production outcome of the manufacturing process; and
a semi-value-add (SVA) activity when the actionable activity indirectly contributes to the production outcome of the manufacturing process, wherein revising the manufacturing process includes eliminating the actionable activities labelled as the NVA activity and revising the actionable activities labelled as the SVA activity.

8. The method of claim 1, wherein the manufacturing facility contains a network of Internet of Things (IoT) devices used for the manufacturing process, and wherein revising the manufacturing process includes modifying a set of programmed device actions of one or more automated devices in the network IoT devices based on the modified workflow process.

9. The method of claim 1, wherein the manufacturing facility contains a robotic device operating in conjunction with the human for the manufacturing process, and wherein revising the manufacturing process includes modifying a set of programmed robot actions of the robotic device based on the modified workflow process.

10. The method of claim 1, wherein revising the manufacturing process includes generating an interactive operational dashboard presenting the modified workflow process and multiple user-selectable and modifiable key performance indicators (KPIs).

11. The method of claim 1, wherein the predefined motion groups include a body bending group, a knee bending group, a head movement group, a leg movement group, and/or a posture group.

12. The method of claim 11, wherein the predefined activity descriptions include a forward or backward movement for the body bending group, a crouching or kneeling movement for the knee bending group, a tilt, turn or nod movement for the head movement group, a walk or step movement for the leg movement group, and/or an ergonomic risk or inefficient movement for the posture group.

13. The method of claim 1, wherein analyzing the digital video data includes evaluating the multiple movements performed by the human to detect a hand movement, a finger movement, a grasping movement, an arm movement, a torso movement, a head movement, a body bending movement, a knee bending movement, a posture analysis, and/or a leg movement.

14. A non-transient, computer-readable medium (CRM) storing instructions executable by a system controller of a smart manufacturing system for producing a product by a human within a manufacturing facility, the instructions, when executed, causing the system controller to perform operations comprising:
receiving, from an optical imaging device within the manufacturing facility, digital video data of the human performing multiple movements during a manufacturing process;
analyzing, using a supervised machine learning (SML) model, the digital video data to identify a sequence of motions within the multiple movements;
categorizing each motion in the sequence of motions into one of multiple predefined motion groups to generate a set of cataloged actions;
translating each action in the set of cataloged actions into one of multiple predefined activity descriptions to generate a set of actionable activities;
mapping each actionable activity in the set of actionable activities to one of multiple predefined map codes to generate a set of mapped activities;
converting, using a rules engine, each mapped activity in the set of mapped activities to one of multiple time measurement unit (TMU) values; and
revising the manufacturing process using the TMU values assigned to the mapped activities to generate a modified workflow process.

15. The non-transient CRM of claim 14, wherein analyzing the digital video data to identify the sequence of motions includes:
training the SML model with a labelled data set containing labelled motion data points with corollary action labels to perform comprehensive motion analysis; and
detecting, using trained SML model, movement patterns across the body of the human within the movements performed by the human during the manufacturing process to distinguish elemental motions contained therein into the sequence of motions.

16. The non-transient CRM of claim 14, wherein generating the set of actionable activities includes:
retrieving, from a system database, a respective set of standardized activity descriptions assigned to each of the predefined motion groups; and
converting each motion within each of the predefined motion groups to one of the standardized activity descriptions assigned to the predefined motion group of the motion.

17. The non-transient CRM of claim 16, wherein generating the set of mapped activity codes includes:
retrieving, from the system database, a standardized mapping code ascribed to each of the standardized activity descriptions; and
assigning one of the standardized mapping codes to each of the actionable activities.

18. The non-transient CRM of claim 17, wherein converting each of the mapped activities includes:
retrieving, from the system database, a standardized TMU value ascribed to each of the standardized mapping codes; and
assigning a corresponding one of the standardized mapping codes to each of the mapped activities in the set of mapped activities.

19. The non-transient CRM of claim 14, wherein the instructions further cause the system controller to:
calculate a mathematical sum of the TMU values of the converted set of mapped activities; and
calculate a TMU time standard for the manufacturing process by multiplying the mathematical sum of the TMU values by a predefined TMU scalar, wherein revising the manufacturing process is based on the calculated TMU time standard.

20. The non-transient CRM of claim 14, wherein the instructions further cause the system controller to label each actionable activity in the set of actionable activities as:
a value-add (VA) activity when the actionable activity directly contributes to a production outcome of the manufacturing process;
a non-value-add (NVA) activity when the actionable activity directly detracts from the production outcome of the manufacturing process; and
a semi-value-add (SVA) activity when the actionable activity indirectly contributes to the production outcome of the manufacturing process,
wherein revising the manufacturing process includes eliminating the actionable activities labelled as the NVA activity and revising the actionable activities labelled as the SVA activity.
